(19) United States
(12) Patent Application Publication
(10) Pub. No.: US 2023/0410054 A1
(43) Pub. Date: Dec. 21, 2023

(54) MULTI-ATTRIBUTE MATCHING FOR CANDIDATE SELECTION IN RECOMMENDATION SYSTEMS

(71) Applicant: Microsoft Technology Licensing, LLC, Redmond, WA (US)

(72) Inventors: Shaghayegh Gharghabi, Mountain View, CA (US); Huichao Xue, Santa Clara, CA (US)

(21) Appl. No.: 17/842,128

(22) Filed: Jun. 16, 2022

(51) Int. Cl. G06Q 10/10; G06F 16/9535; G06N 20/00

(52) U.S. Cl. CPC G06Q 10/1053; G06F 16/9535; G06N 20/00

(57) ABSTRACT

Described herein is a candidate selection technique for an online recommendation system or service. Upon receiving a request to generate recommendations for an end-user, attributes of the end-user are obtained. The end-user attributes are then provided as an input to a trained machine learned model, which generates for each attribute a score indicating the predictive power of the attribute in recommending a relevant content item (e.g., an online job posting). Then, a weighted-OR query is derived from a combination of attributes having scores that exceed a predetermined threshold. The query is expressed, such that, content items satisfying the query include at least “k” attributes specified by the query.

### TECHNICAL FIELD

The present application generally relates to computer-implemented recommendation systems. More specifically, the present application relates to a recommendation system for online job postings with a candidate selection technique that leverages machine learning to rank and select attributes to be used with a query for selecting the candidate job postings.

### BACKGROUND

Many online or web-based applications, services and sites have recommendation systems for deriving recommendations for presentation to end-users. By way of example, e-commerce sites have recommendation systems for recommending products, digital content, and/or services. Online dating services may provide recommendations relating to people of potential interest for dating. An online job hosting service allows those who are seeking employees to create and post online job postings that describe available job opportunities, while simultaneously allowing those seeking job opportunities to browse recommended online job postings and/or search for online job postings.

To generate relevant recommendations, many recommendation systems use attributes of end-users to generate queries that fetch candidate content items, before ranking the candidate content items, and then presenting as recommendations a subset of the highest-ranking content items. This two-step paradigm generally involves a retrieval step—frequently referred to as a candidate selection or candidate retrieval step—followed by a separate ranking step. Typically, during the candidate selection step, content items are fetched by matching end-user attributes with corresponding attributes of content items being considered for recommendation.

By way of example, in the context of an online job hosting service, an end-user may have a user profile that specifies a skill possessed by the end-user. During the candidate selection step, a recommendation system may retrieve all job postings that specify a required skill that matches the skill possessed by the end-user, as reflected by the end-user's profile. Once the candidate job postings are fetched, a ranking algorithm is applied to rank the job postings. Finally, several of the highest-ranking job postings are selected for presentation as job recommendations to the end-user. As set forth below, embodiments of the present invention provide an improved candidate selection technique for use with recommendation systems.

### BRIEF DESCRIPTION OF THE DRAWINGS

Embodiments of the present invention are illustrated by way of example and not limitation in the figures of the accompanying drawings, in which:

FIG. 1 is a diagram illustrating an example of a conventional candidate selection technique, for use with an online recommendation service or system;

FIG. 2 is a diagram illustrating another example of a conventional candidate selection technique, for use with an online recommendation service or system;

FIG. 3 is a diagram illustrating an example of an improved candidate selection technique for use with an online recommendation service or system, consistent with embodiments of the invention;

FIG. 4 is a diagram illustrating an example of a technique for training a machine learning model for use in ranking attributes to be used in a query of a candidate selection technique, consistent with embodiments of the invention;

FIG. 5 is a diagram illustrating examples of weighted-OR queries derived by a query rewriter, consistent with embodiments of the invention;

FIG. 6 is a flow diagram illustrating a technique for deriving recommendations for content items (e.g., online job postings), consistent with an embodiment of the present invention;

FIG. 7 is a block diagram illustrating a software architecture, which can be installed on any of a variety of computing devices to perform methods consistent with those described herein; and

FIG. 8 illustrates a diagrammatic representation of a machine in the form of a computer system within which a set of instructions may be executed for causing the machine to perform any one or more of the methodologies discussed herein, according to an example embodiment.

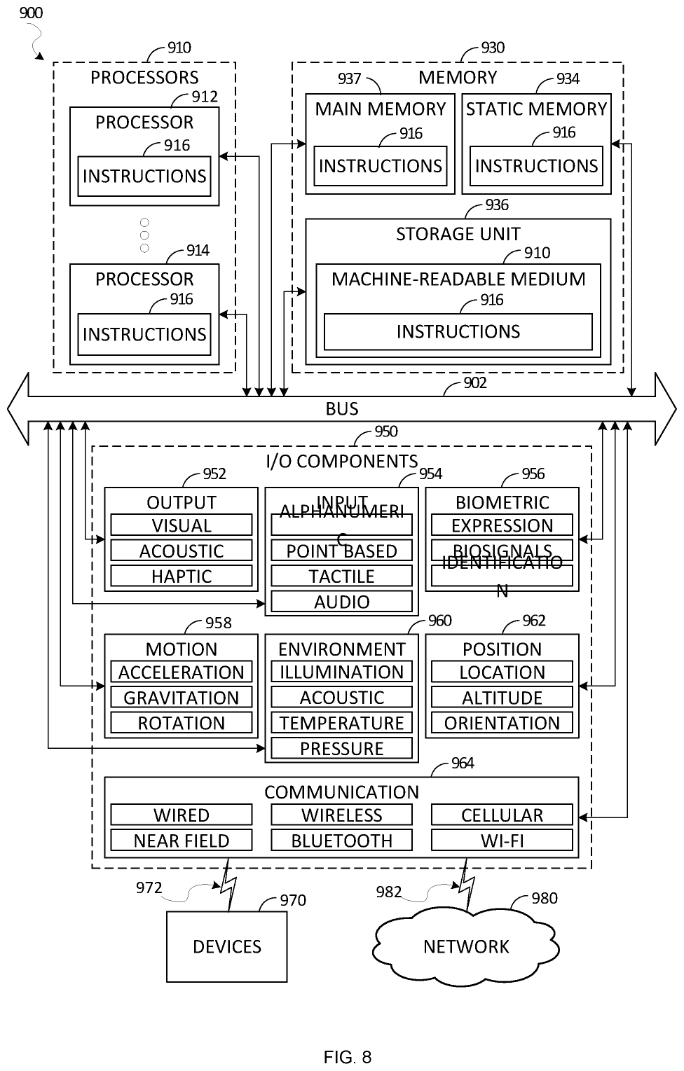

### DETAILED DESCRIPTION

Described herein are techniques for selecting candidate content items (e.g., online job postings) for an online recommendation service or system. Specifically, the present disclosure describes a technique for training and using a machine learned model to rank attributes of an end-user, so that a query can be generated with a combination of high-ranking attributes that are likely to return relevant content items. To ensure that the selected candidate content items are relevant, the machine learning model is optimized using a loss function that expresses similarity between an end-user and a content item as a match between at least “k” attributes. The query that is generated to fetch candidate content items is derived to ensure that the fetched candidate content items have “k” or more attributes that match those specified in the query. In the following description, for purposes of explanation, numerous specific details and features are set forth to provide a thorough understanding of the various aspects of different embodiments of the present invention. It will be evident, however, to one skilled in the art, that the present invention may be practiced and/or implemented with varying combinations of the many details and features presented herein.

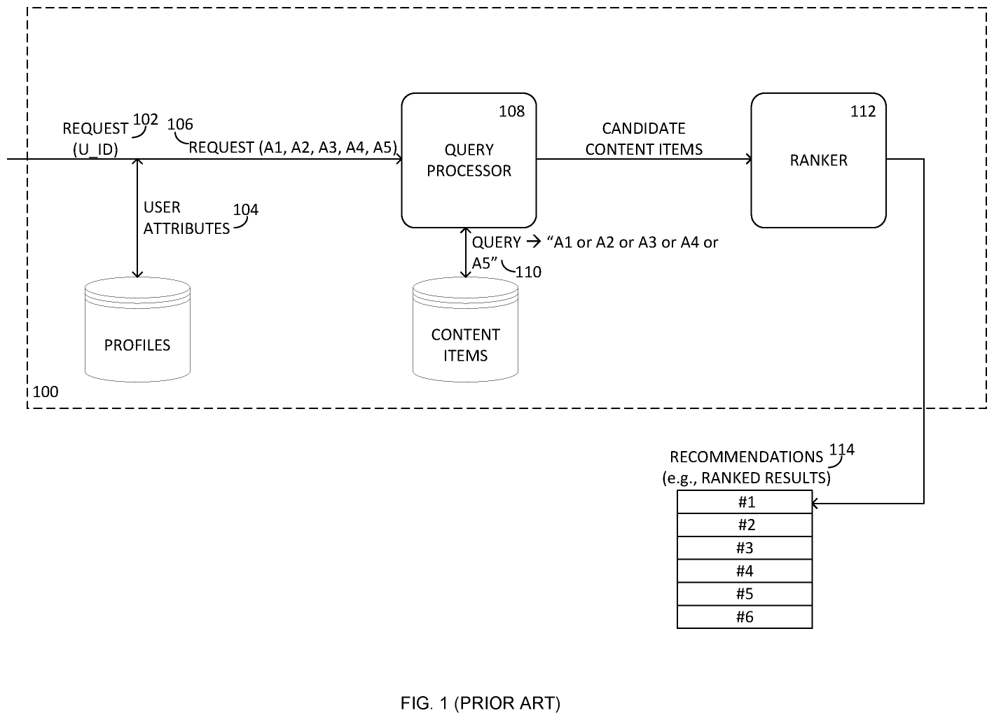

Referring now to FIG. 1, a flow diagram consistent with a conventional candidate selection technique is illustrated. As shown in FIG. 1, some conventional candidate selection techniques involve fetching all content items that have at least one attribute that matches with any one end-user attribute. For instance, as shown in FIG. 1, a request 102 to derive recommendations for an end-user is received at the recommendation system 100. The request identifies the end-user (e.g., U_ID) for whom a set of recommendations is to be generated and presented. Using the information identifying the end-user (e.g., U_ID), user attributes 104 of the end-user are obtained. For the sake of simplicity, in this example, the end-user is associated with five attributes, shown in FIG. 1 as “A1,” “A2,” “A3,” “A4” and “A5.” Although not expressly shown in FIG. 1, each attribute consists of an attribute name and an attribute value. For instance, in the context of an online job hosting service, an attribute may have an attribute name such as, Company Name, with an attribute value such as, ACME, Inc.

The request, including the set of user attributes for the end-user 106, is then provided as an input to a query processor 108. The query processor formulates a query 110 to be executed against a datastore 112 of content items. In this example, the query 110 is formulated with individual terms expressing each of the individual attributes and joined by a Boolean OR operator. For instance, the first term is represented in the query as “A1” for a first attribute. Accordingly, upon executing the query to fetch the candidate content items, any content item having a single attribute matching one of the several attributes (e.g., attributes, “A1” or “A2” . . . or “A5”) expressed by the several terms of the query will satisfy the query. Once the candidate content items have been fetched, the candidate content items are ranked by a ranker 112 before a subset of high-ranking content items are selected and presented as recommendations 114 to the end-user.

When the content items are stored using a pre-built index, (e.g., Lucene, or key-value store), the fetching of the content items occurs very quickly. However, as the number of attributes under consideration increases, it takes more time to fetch the content items and the overall relevance of each content item decreases. Although the example of FIG. 1 includes only five attributes, in many recommendation systems, there may be hundreds of attributes by which an end-user can be matched with content items. Therefore, the candidate selection technique described in connection with FIG. 1 ultimately results in suboptimal content item recommendations, as the downstream ranker(s) 112 make more mistakes when processing a large number of irrelevant content items. For example, when the candidate content items include a large number of irrelevant content items, the ranked results 11 are more likely to include one or more irrelevant content items. Furthermore, queries based on this technique may require significant computational resources, resulting in a heavy processing load on the servers.

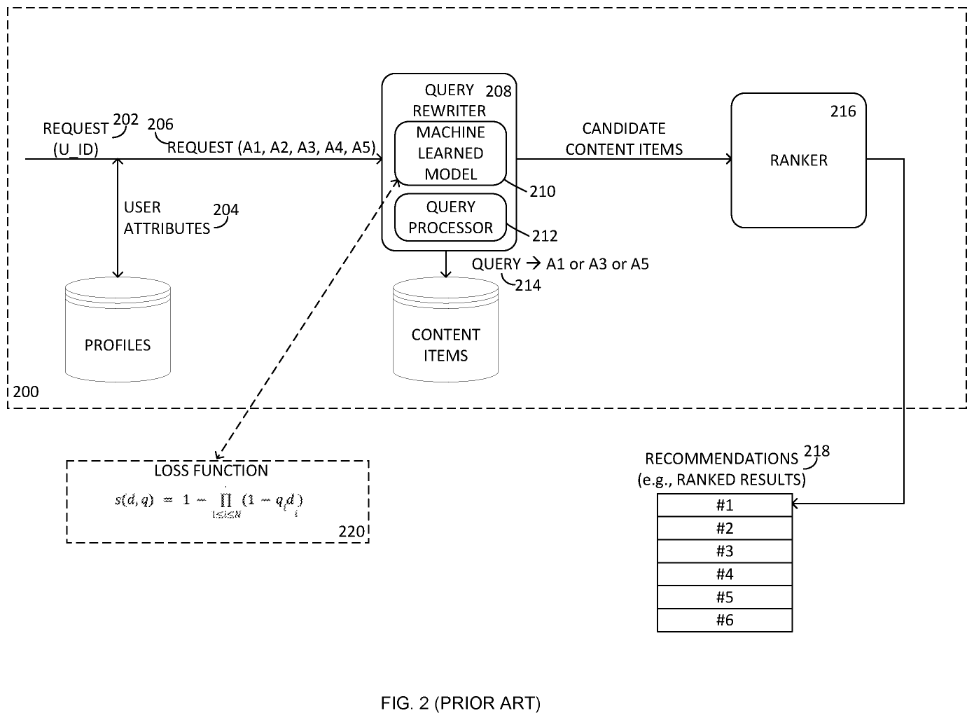

Turning now to FIG. 2, an alternative candidate selection technique is shown, which improves upon the performance of the technique described in connection with FIG. 1. Rather than deriving a query to include terms for all attributes of the end-user, as described in the example set forth above, the candidate selection technique illustrated in FIG. 2 involves a pre-trained machine learned model, which scores the attributes based on their effectiveness in selecting relevant content items, so that only those attributes with the most predictive power can be selected for use with a query. For example, a pre-trained machine learned model receives as input the attributes of the end-user, and then outputs a score for each attribute. Here, the score reflects the predictive power of the attribute in selecting candidate content items that will be relevant for the end-user. Accordingly, after scoring the attributes, a query is generated to include only attributes that have scores exceeding some predetermined threshold. Using queries derived with high-ranking attributes results in the selection of more relevant candidate content items, and reduces the chance of recommending a content item that was selected based on a matching attribute with little or no importance in predicting the relevance of a content item.

As shown in FIG. 2, a request 202 to derive recommendations for an end-user is received at the recommendation system 200. The request identifies the end-user (e.g., U_ID) for whom a set of recommendations is to be generated and presented. Using the information identifying the end-user (e.g., U_ID), user attributes 204 of the end-user are obtained. Here again, in this simplified example, the end-user is associated with five attributes, shown in FIG. 2 as “A1,” “A2,” “A3,” “A4” and “A5.” The request, including the set of user attributes for the end-user 206, is then provided as input to a query rewriter 208. A pre-trained machine learned model 210 receives, as input, the end-user attributes, and then derives for each attribute a score. The scored attributes are then processed by the query processor 212 to derive a query 214 that includes a term for each attribute having a score that exceeds a predetermined threshold. By way of comparison, the query 214 shown in FIG. 2 includes only three terms—one for each attribute (“A1,” “A3,” and “A5”), combined via Boolean OR operators—whereas the query 110 of FIG. 1 includes five terms, expressing five attributes. In this example shown in FIG. 2, the attributes for “A2” and “A4” have scores that are less than the predetermined threshold, and are therefore not included as terms in the query 214. The query 214 is executed to fetch relevant candidate content items, which are then ranked by the ranker 216, before a subset of the ranked content items are selected for presentation as content item recommendations 218.

A candidate selection technique consistent with that shown in FIG. 2 and described immediately above is presented in U.S. Pat. No. 11,238,124, with title, “SEARCH OPTIMIZATION BASED ON RELEVANT-PARAMETER SELECTION” (hereafter, “the '124 patent”). The candidate selection technique described in the '124 patent is an improvement upon the candidate selection technique described in connection with FIG. 1 above. Specifically, the technique described in the '124 patent does not attempt to use all attributes of an end-user to fetch candidate job postings. Instead, a pre-trained machine learned model is used to generate for each attribute (referred to in the '124 patent as a parameter) a score (e.g., a parameter preference score). Then, a query is derived to include clauses or terms corresponding with only those attributes that have a score that exceeds a threshold. Accordingly, by selecting only the most relevant attributes to include in the query, fewer, but more relevant, content items are fetched.

The candidate selection technique illustrated and described in connection with FIG. 2 is an improvement over that described in connection with FIG. 1. As indicated in FIG. 2, the similarity function or loss function 220 used in training the machine learned model 210 is as shown:

$$\\ s ( d , q ) = 1 - {\dot{\prod }}_{1 \leq i \leq N} ( 1 - {q}_{i} {d}_{i} )$$

Here, “S” is a similarity function whose value is derived from a document “d” (representing a content item) and a query “q” (representing an end-user), where “i” represents an index for the number “N” of attributes. If no attributes are shared in common between the query (end-user) and document (content item), the expression “qᵢdᵢ” evaluates to zero, indicating that the query and the document are not similar. However, when just one attribute is shared in common between the query (end-user) and the document (content item), the expression “qᵢdᵢ” evaluates to one, indicating the query and document are deemed to be similar. Because the query rewriter 208 derives the query 214 with Boolean OR operators, the result is that, in some instances, a candidate content item may be fetched on the basis of the content item having only one attribute shared in common with the end-user. This may lead to confusingly poor results. Specifically, in the context of an online job hosting service, an end-user may be presented with one or more recommended job postings that are not at all suitable for, and/or of interest to, the end-user.

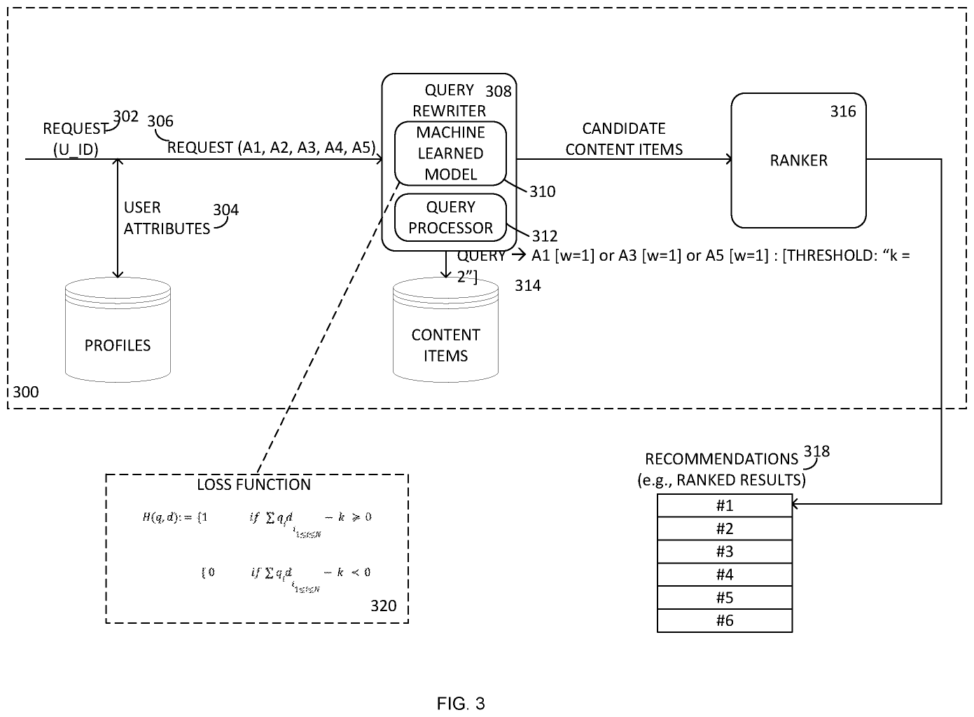

Embodiments of the present invention address the technical problems of the prior art by improving the manner in which a machine learning model is trained to score attributes, and improving the manner in which a query rewriter derives a query, based on scored attributes, for use in selecting candidate content items. Turning now to the diagram illustrated in FIG. 3, an improved candidate selection technique is presented. Upon receiving, at a recommendation system 300, a request 302 to generate recommendations for an end-user, attributes 304 of the end-user are obtained. By way of example, these end-user attributes may include profile attributes, such as may be found in a user profile of the end-user. The end-user attributes may also include activity-based attributes. For instance, when an end-user performs a search and specifies a search query (e.g., “software engineering positions”), the search query may be analyzed to derive an activity attribute that is then associated with the end-user.

The request, including the end-user attributes 306, is then provided as input to a query rewriter 308. A pre-trained machine learned model 310 derives for each attribute a score representing a predictive power of the attribute in identifying relevant content items for the end-user. As reproduced below and as shown in FIG. 3, the similarity function or loss function 320 used in training the machine learned model 310 is based on a modified version of the Heaviside Step function,

$$\\ \begin{matrix}H ( q , d ) : = \{ \begin{matrix}1 & if \sum {q}_{i} {d}_{{i}_{1 \leq i \leq N}} - k ≽ 0\end{matrix} \\ \{ \begin{matrix}0 & if \sum {q}_{i} {d}_{{i}_{1 \leq i \leq N}} - k ≺ 0\end{matrix}\end{matrix}$$

Similar to the loss function (“S”) shown in FIG. 2, here, “H” is a function of the attributes for a query, “q” (representing an end-user) and a document, “d” (representing a content item). However, in this instance, the expression “qᵢdᵢ” evaluates to one, indicating that the query and the document are similar, only when the number of attributes shared in common between “q”, the query (e.g., expressing attributes of the end-user), and “d”, the document (representing attributes of the content item), is equal to or greater than “k.” Similarly, the expression “qᵢdᵢ” evaluates to zero when the number of attributes in common is less than the value for “k.” Accordingly, by setting “k” to a value of two (or greater) the machine learned model can be optimized to generate scores for attributes based on a concept of similarity that requires two (or more) attributes to be shared in common between the query (e.g., the end-user) and the document (e.g., the content item). This is in contrast with the loss function of the machine learning model shown in FIG. 2, which optimizes the scoring of attributes based on single attribute similarity.

Continuing with the example shown in FIG. 3, after the machine learned model 310 has generated scores for each of the attributes of the end-user, the query processor 312 of the query rewriter 308 derives a query 314 including a term for each attribute having a score that exceeds a predetermined threshold. The query 314 is derived as a weighted-OR query, with individual weighting factors being assigned to each term, and a threshold score for the query. Accordingly, when the query is processed to fetch the candidate content items, the weighting factors associated with terms that express attributes present in a content item are summed, and only when the sum of the weighting factors for matching attributes exceeds the query threshold score, “k,” is the content item considered to satisfy the query. For instance, in the example of FIG. 3, the weighting factor assigned to each term is one (e.g., “w=1”). If a content item has two of the three attributes (e.g., “A1,” “A3” and “A5”), the sum of the weighting factors associated with matching attributes is two. Because two is equal to or greater than the threshold for the query—in this case, two (e.g., “k=2”), the content item is deemed to satisfy the query and the content item is fetched as a candidate content item.

Once the candidate content items have been fetched, the ranker 316 processes the candidate content items to derive a rank or ranking score for each content item. Finally, a subset of the ranked content items 318 is selected for presentation to the end-user, based on their respective ranking scores, and the selected content items are presented in an order that is based on their respective rank. By scoring attributes with a machine learned model that has been optimized to determine similarity based on “k” attributes, and generating queries that require “k” common attributes between the query and the content item, the overall relevancy of the candidate content items selected is increased, as compared to conventional candidate content selection techniques.

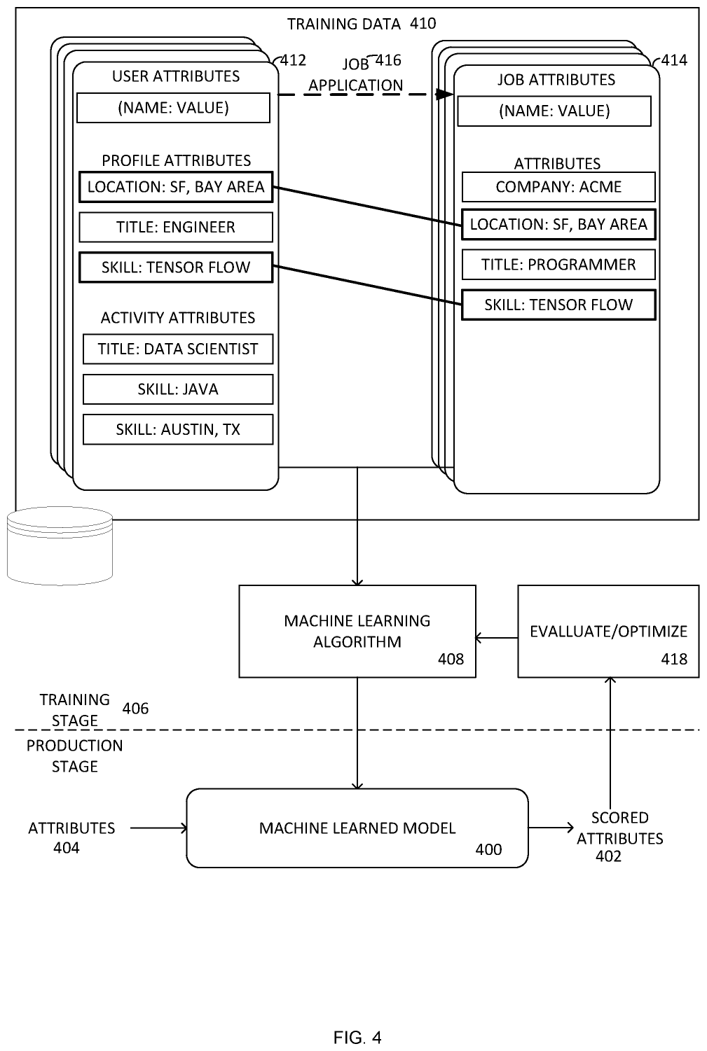

FIG. 4 is a diagram illustrating an example of various functional components providing for a technique to train a machine learned model 400 for use in scoring attributes to be used in a query of a candidate selection technique, consistent with embodiments of the invention. Consistent with some embodiments, the objective of the candidate selection technique is to fetch the most relevant content items (e.g., job postings) for an end-user. Accordingly, the goal of the candidate selection technique involves writing a query that will maximize, Pr(+|U, d). That is, the goal is to maximize the probability (“Pr”) that a user (“U”) finds a document (“d”) to be relevant. Consistent with embodiments of the invention, a machine learned model 400 is trained to generate as output, scores 402, for each attribute 404 received as an input, where the scored attributes 402 are then used for the purpose of aligning the query generation with the goal of maximizing, Pr(+|U, d).

As illustrated in FIG. 4, during a training stage 406, a machine learning algorithm 408 or training system is provided with example inputs (e.g., training data 406), with the objective of learning a function (e.g., as represented by the model 400) that will map the example inputs (e.g., attributes 404) to the outputs (e.g., scores 402 for attributes). The example inputs and outputs that are used to train the model 400 are generally referred to as the training data 410. In this instance, the training data 410 are derived from attributes obtained from pairs of users and job postings. Specifically, the training data 410 are obtained by identifying attributes associated with a user who applied for a particular job posting. For instance, as shown in FIG. 4, the training data 410 consists of pairs of user attributes 412 associated with a user and job attributes 414 from a job posting to which the user submitted a job application 416.

During the training stage 406, after each instance of training data is processed by the machine learned model 400 to generate scores 402 for the attributes 404, an evaluation or optimization operation 418 is performed to determine how to manipulate the weights of the machine learned model 400 to generate more accurate predictions (e.g., scores). For example, the evaluation operation generally involves comparing the predicted output of the machine learned model with the actual output associated with the example input. A loss function is used to evaluate the performance of the model in generating the desired outputs, based on the provided inputs.

During the training stage 406, as the training data are provided to the learning system 408, the weights of the individual neurons of the neural network model 400 are manipulated to minimize the error or difference, as measured by the loss function. Once fully trained and deployed in a production setting 420, the model 400 is provided with a set of attributes for an end-user, for whom content recommendations are to be generated. The machine learned model 404 then generates the scores 402 for the received attributes. Finally, the query rewriter selects those attributes that have scores exceeding some predetermined threshold, for use in a weighted OR query for selecting the candidate content items (e.g., job postings).

Consistent with some embodiments, each content item or job posting (represented for purposes of modeling as a document, “d”) is represented as an embedding—a high dimensional binary vector with “N” dimensions, with d∈{0, 1}N, where each dimension corresponds with an attribute (e.g., “skill=TENSOR FLOW” and “title=ENGINEER”). Similarly, the attributes of an end-user (represented for modeling as a query, “q”) is also represented as an embedding (e.g., a high dimensional binary vector) in the same space, d∈{0, 1}N. Accordingly, if the attributes of any given end-user (e.g., query, “q”) are similar (e.g., match) the attributes of a content item or job posting (e.g., document, “d”), then the probability of the content item or job posting (e.g., document, “d”) being relevant to the end-user (e.g., query, “q”) increases. Thus, with the goal being to find relevant content items (e.g., job postings) to present to the end-user, the selection of an appropriate loss function is important to achieve the goal.

Consistent with some embodiments of the present invention, the similarity of loss function used to optimize the machine learned model is based on the Heaviside Step function:

$$\\ \begin{matrix}H ( q , d ) : = \{ \begin{matrix}1 & if \sum {q}_{i} {d}_{{i}_{1 \leq i \leq N}} - k ≽ 0\end{matrix} \\ \{ \begin{matrix}0 & if \sum {q}_{i} {d}_{{i}_{1 \leq i \leq N}} - k ≺ 0\end{matrix}\end{matrix}$$

Here, “k” is the number of attributes matching between the query, “q” (e.g., the end-user) and the document, “d” (e.g., the content item or job posting). However, as the Heaviside Step function is not a continuous function, the following logistic function, which is a smooth and continuous approximation of the Heaviside Step function, may be used:

$$\\ \begin{matrix}H ( q , d ) : = \frac{1}{2} + \frac{1}{2} tanh ( rqd ) \\ = \frac{1}{1 + {e}^{- 2 r ( \sum {q}_{i} {d}_{i} - k )}}\end{matrix}$$

Here, the larger the choice of “r”, the sharper the transition will be at the origin.

During information retrieval, the arguments of the maxima (abbreviated as the arg-max) of the loss function is determined. Because log(x) is an increasing function, a maximum for the loss function, H(x), implies a maximum for, log(H(x)),

$$\\ {H}_{i} = log ( H ( x ) ) = > {H}_{i} = log ( \frac{1}{1 + {e}^{- 2 r ( \sum {q}_{i} {d}_{i} - k )}} ) = - log ( 1 + {e}^{- 2 r ( \sum {q}_{i} {d}_{i} - k )} )$$

Because e^{ƒ(x)} is convex and arg-max log(1+ƒ(x)) is the same as arg-max of log(ƒ(x)) we have:

$$\\ {H}_{i} = - log ( {e}^{- 2 r ( \sum {q}_{i} {d}_{i} - k )} ) = 2 r {\sum }_{i = 1}^{N} {q}_{i} {d}_{i} - 2 rk$$

In addition, the embedding spaces of the query and document are discrete. For instance, the query, “q” has dimensions that are between the values of zero and one, making back-propagation difficult. Therefore, to enable back propagation, the query embedding is smoothed using the sigmoid function as follows:

$$\\ q = σ ( \frac{f}{T} )$$

where, ƒ∈R^{N}, which can take any real number and T>0 is the level of smoothness. If T is close to 0, depending on the sign of ƒ, q can take discrete values, that is, either zero (0) or one (1). When T is close to one (1), the query, “q” will have a soft value lying anywhere between zero (0) and one (1).

$$\\ {q}_{i} = σ ( \frac{{f}_{i}}{T} ) and T = 1 = > {H}_{i} = 2 r {\sum }_{i = 1}^{N} σ ( {f}_{i} ) {d}_{i} - 2 rk$$

The loss function, H(x), is aligned with the goal, Pr(+|U, d), using cross entropy.

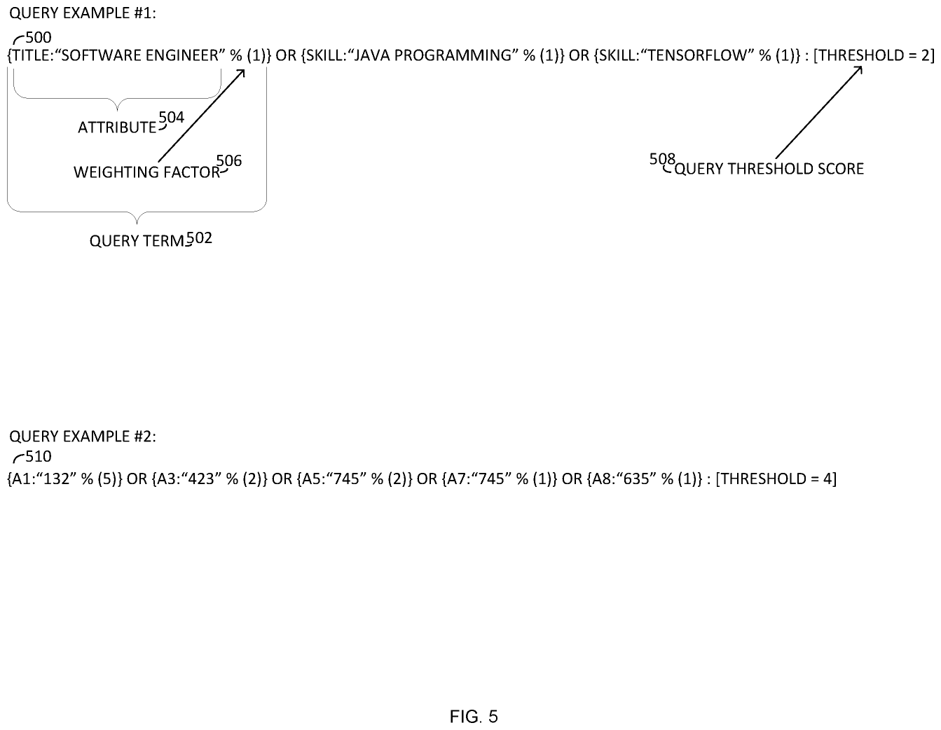

FIG. 5 is a diagram illustrating examples of weighted-OR queries, consistent with embodiments of the invention. Consistent with some embodiments, after the end-user attributes have been scored by the machine learned model 310, the query rewriter 308 generates a weighted-OR query with a plurality of terms—one term for each attribute that has a score exceeding a predetermined threshold. The terms specifying the attributes are connected by OR operators, and the attribute expressed by each term is assigned a weighting factor. Additionally, the query is assigned a query threshold score. Upon evaluating the query against a particular content item (e.g., an online job posting), a score is derived for the particular content item by adding or summing the weighting factors of each term of the query associated with an attribute that is present in the content item. If the resulting score for the content item is equal to or greater than the query threshold score, then the content item is deemed to satisfy the query, and the content item is fetched as a candidate content item. Those skilled in the art will appreciate that the query expressions shown in FIG. 5 are provided to convey an understanding of the present invention, and the actual syntax or query language used to express a query may differ significantly depending upon a variety of factors, including the choice of query language and search system(s).

By way of example, consider the query expression 500 shown in FIG. 5 and labeled as “QUERY EXAMPLE #1.” In this example, the query has three separate query terms, with each query term joined by an OR operator. For instance, the expression, “{TITLE:“SOFTWARE ENGINEER” % (1)}” is one query term 502. The query term 502 indicates an attribute 504 having an attribute name (e.g., “TITLE”) and an attribute value (e.g., “SOFTWARE ENGINEER”). In addition, the query term 502 specifies a weighting factor 506 for the attribute 504 expressed in the term 502. Finally, the query 500 also expresses a query threshold score 508—in this instance, two (“2”).

For a given content item, the query is evaluated by determining which, if any, attributes expressed in the various terms are present in the content item—meaning, the content item expresses corresponding attributes. By way of example, if the content item is a job posting, and the job posting indicates the job being promoted has a job title of “software engineer,” then the query term 502 would be considered to have a corresponding, matching attribute expressed in the job posting. To determine whether the content item satisfies the query, the sum of the weighting factors associated with matching attributes is compared with the query threshold score 508. If the score (e.g., sum of weighting factors) is equal to or greater than the query threshold score 508 for a particular content item, then that content item is deemed to satisfy the query, and the content item is fetched as a candidate content item.

Continuing with the example, if a content item—in this instance, an online job posting—indicates a job being promoted has a job title of “software engineer,” and lists as a required skill, “TensorFlow,” then the online job posting satisfies the query because the sum of the weighting factors is two (e.g., one plus one equals two), which, in this instance, is equal to the query threshold score (e.g., “THRESHOLD=2”) 508. Similarly, if an online job posting indicates a job being promoted has a job title of “marketing specialist,” and lists as a required skill, “TensorFlow,” and no other attributes expressed in the query match those expressed in the job posting, then the online job posting would not satisfy the query because the sum of the weighting factors is one, which, in this instance, is less than the query threshold score (e.g., “THRESHOLD−2”) 508.

In FIG. 5, in the example labeled as “Query Example #1,” each attribute has been assigned a weighting factor of one (“1”) and the query threshold score has been set to two (“2”). Accordingly, any content item that has two or more attributes that match those expressed in the query will satisfy the query, and will be fetched as a candidate content item, as a result of executing the query. This of course will eliminate the chance that a recommendation is made to the end-user, where the recommended content items is a content item having only one attribute that matches a corresponding attribute of the end-user.

Turning now to the example in FIG. 5 labeled as “QUERY EXAMPLE #2,” a more complex query expression is shown. In the second example, the query 510 includes five separate terms, expressing five different attributes with generic attribute names (e.g., “A1,” “A3,” “A5,” “A7” and “A8”). In this example, the attribute values are shown as numbers (e.g., “132” for “A1”), which may be an embedding (e.g., a vector representation) or another representation of the text corresponding with the actual attribute value. The various weighting factors assigned to each attribute vary from five (“5”) for the attribute with attribute name, “A1,” to one (“1”) for the attribute with attribute name, “A8.” The query threshold score for the query is four (e.g., “THRESHOLD=4). Accordingly, various combinations of matching attributes, when present in a content item, will result in the content item satisfying the query. For instance, if a content item includes the attribute associated with the attribute having the attribute name, “A1,” then the content item will satisfy the query, even when no other attributes match, because the weighting factor (e.g., “5”) associated with the attribute, “A1,” exceeds the query threshold score of four (“4”). Similarly, if a content item has matching attributes for “A3” (e.g., with weighting factor two (“2”)), and “A5” (e.g., with weighting factor two (“2”), the content item will satisfy the query (e.g., two plus two equals four, which is equal to the query threshold score). By formulating the query expressions as weighted-OR queries, the queries can be expressed to require a certain number of matching attributes (e.g., consistent with Example #1). Alternatively, more complex queries can be derived with weighting factors that express the relative importance of the attributes to which the weighting factors are assigned.

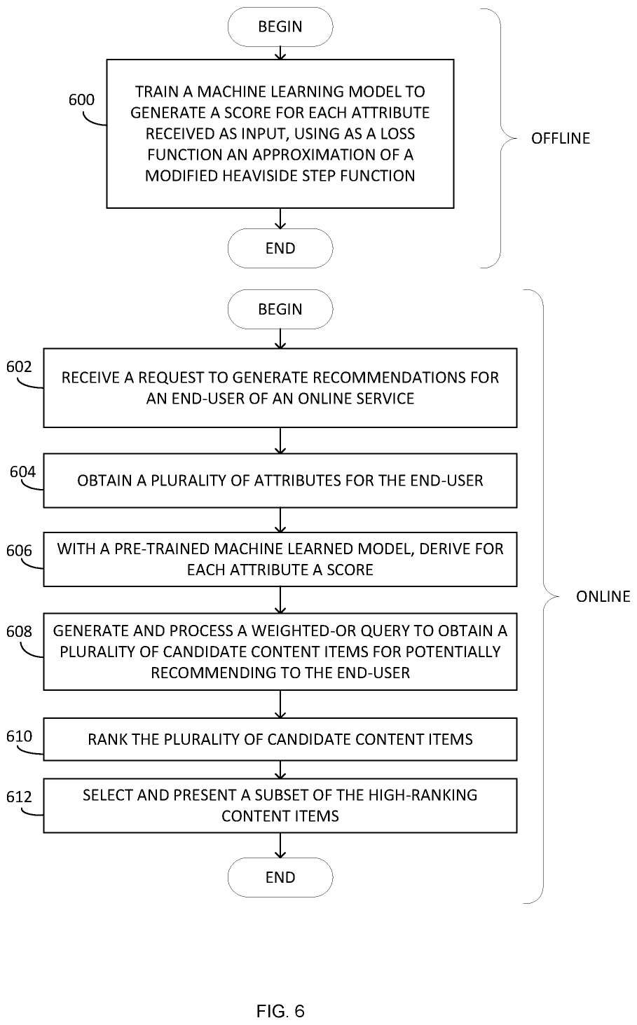

FIG. 6 is a flow diagram illustrating a technique for deriving recommendations for online job postings, consistent with an embodiment of the present invention. In FIG. 6, the method operations are divided into those that occur offline, and those that occur online—for example, in a live production setting. For instance, at operation 600, a machine learning algorithm is used, with training data, to train a machine learning model to receive as input a plurality of attributes, and generate a score, as output, for each attribute. The training of the machine learning model is described above in connection with FIG. 4, and differs from conventional techniques in that the loss function used to train the model is based on a similarity function that defines similarity between an end-user and a content item as requiring two or more matching attributes. For instance, with some embodiments of the invention, the loss function is an approximated, modified version of a Heaviside Step function.

Subsequent to training the machine learning model, the model (now referred to as a pre-trained model) is deployed in a production setting, such as that illustrated in FIG. 3. At method operation 602, a request to derive a plurality of content item recommendations (e.g., job posting recommendations) for an end-user is received at the recommendation system. Generally, the request will identify the end-user for whom the recommendations are to be derived, and in some instances, the request may also include one or more parameters for use as input features for the machine learning model. At method operation 504, attributes associated with the end-user are obtained. For instance, using the identifying information, identifying the end-user on whose behalf the request was invoked, a call to a data store is made to request attributes of the end-user. The end-user attributes may be profile attributes, including various elements of data provided or specified by the end-user as part of his or her end-user profile. Additionally, the end-user attributes may be any of a variety of derived profile attributes. For instance, a derived profile attribute may be an attribute relating to the end-user that is inferred from a combination of one or more end-user profile attributes, and information relating to any of a number of activities or content interactions of the end-user, via the online service. The end-user attributes may also include activity attributes derived directly from an interaction or activity undertaken by the end-user. By way of example, if an end-user performs a search via a search engine or search services provided as part of the online service, the search query specified by the end-user may be analyzed to determine one or more attributes. Similarly, if an end-user selects a content item (e.g. a job posting, or an end-user profile of another end-user), information from the selected and/or viewed content item may be used to derive an activity attribute associated with the end-user.

At method operation 606, the attributes of the end-user, as obtained at method operation 604, are provided as input to the pre-trained machine learned model. The machine learned model processes the attributes to derive for each attribute a score. The score represents a predictive power of the attribute when used as a term in a query to select relevant content items for the end-user.

At method operation 608, a query processor derives a query with a plurality of attributes having scores, derived by the machine learned model (e.g., at operation 606), exceeding a predetermined threshold. With some embodiments, the query is derived as a weighted OR query, as described in connection with the description of FIG. 5. The threshold used to determine which attributes are to be included in the query may be determined through a process of trial-and-error testing. The threshold impacts the number of attributes that qualify for being included in any given query. If the threshold is set to be generally higher, then fewer attributes will have scores exceeding or equaling the threshold, and as a result fewer candidate content items will be selected. However, the overall relevance of those candidate content items that are fetched are more likely to be more relevant. Similarly, a lower threshold will result in more attributes having scores that exceed or equal the threshold, resulting in a greater number of overall candidate content items being fetched. However, the overall relevance of the candidate content items is likely to decrease as the threshold is lowered. Once derived, the weighted OR query is processed to obtain or fetch a plurality of candidate content items.

At method operation 610, the candidate content items are provided as input to a ranker, which processes the candidate content items to rank the candidate content items with relation to one another. The ranking of the candidate content items by the ranker may involve one or more additional pre-trained machine learned models, and input features relating to the end-user and/or candidate content items. Finally, at method operation 612, plurality of content items are selected from the ranked content items, for presentation, as recommended content items, to the end-user. As part of selecting the content items to be presented as recommended content items, a variety of rule-based constraints beyond the scope of the present application may be applied in determining the final selection and order in which the content item recommendations are presented.

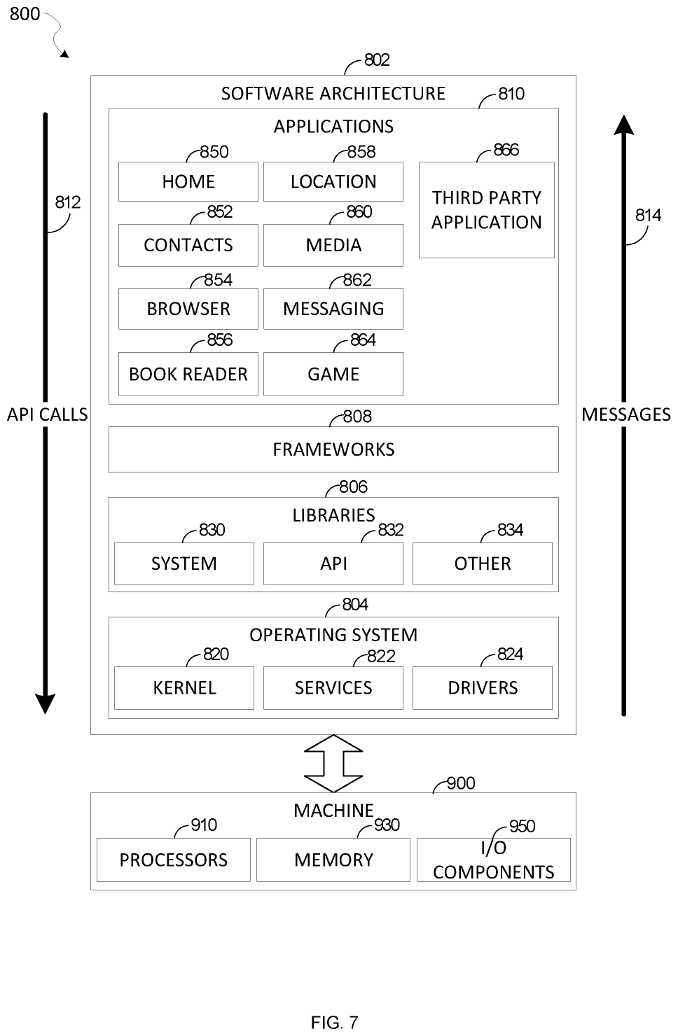

FIG. 7 is a block diagram 800 illustrating a software architecture 802, which can be installed on any of a variety of computing devices to perform methods consistent with those described herein. FIG. 6 is merely a non-limiting example of a software architecture, and it will be appreciated that many other architectures can be implemented to facilitate the functionality described herein. In various embodiments, the software architecture 802 is implemented by hardware such as a machine 900 of FIG. 7 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 606 can include system libraries 830 (e.g., C standard library) that can provide functions such as memory allocation functions, string manipulation functions, mathematical functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the framework 808 provides various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 7 illustrates a diagrammatic representation of a machine 900 in the form of a computer system within which a set of instructions may be executed for causing the machine to perform any one or more of the methodologies discussed herein, according to an example embodiment. Specifically, FIG. 7 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods or algorithms described herein. Additionally, or alternatively, the instructions 916 may implement a system or model as described in connection with FIGS. 3 and 5, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method comprising:
with training data, training a machine learning model to receive as input a plurality of attributes associated with an end-user of an online service and to generate as output a score for each attribute, the score for an attribute indicating the predictive power of the attribute when used as a term of a query for use in selecting candidate job postings to recommend to the end-user, the training data comprising a plurality of attributes i) obtained for an end-user and job posting pair for which the end-user has previously applied for a job, associated with the job posting, and ii) having at least “k” attributes for the end-user matching corresponding attributes of the job posting;
subsequent to training the machine learning model:
receiving a request to generate a plurality of job posting recommendations for a first end-user of the online service;
responsive to receiving the request, obtaining a plurality of attributes associated with the first end-user;
providing the plurality of attributes associated with the first end-user as input to the machine learning model to generate for each attribute a score indicating the predictive power of the attribute when used as a term of a query for use in selecting candidate job postings to recommend to the end-user;
deriving a query for fetching candidate job postings, the query i) including a term for each attribute in the plurality of attributes for which the machine learning model generated a score that exceeds a predetermined threshold, and ii) when executed against a plurality of job postings, fetches as candidate job postings those job postings in the plurality of job postings that have at least “k” attributes matching attributes expressed in the terms of the query;
executing the query to fetch a plurality of candidate job postings;
processing the plurality of candidate job postings to derive a ranking score for each job posting; and
based at least in part on the ranking scores of the plurality of candidate job postings, selecting a subset of the plurality of job postings for presentation as recommendations to the first end-user.

2. The computer-implemented method of claim 1, wherein training the machine learning model comprises using as a loss function an approximation of a modified Heaviside Step function, wherein the modified Heaviside Step function evaluates to one, when a job posting has “k” attributes matching attributes of the end-user, and the modified Heaviside Step function evaluates to zero, when a job posting has less than “k” attributes matching attributes of the end-user.

3. The computer-implemented method of claim 1, wherein deriving a query for fetching candidate job postings comprises:
deriving the query as a weighted OR query.

4. The computer-implemented method of claim 1, wherein deriving the query as a weighted OR query comprises:
assigning to the query a query threshold score; and
assigning to each term in the query a weighting factor;
wherein, upon evaluating the query against a particular job posting, a score is derived for the particular job posting by adding the weighting factors of each term of the query associated with an attribute that is present in the job posting; and
fetching the particular job posting as a candidate job posting when the score for the particular job posting exceeds the query threshold score.

5. The computer-implemented method of claim 4, wherein the threshold score is set to the value of “k” and the weighting factor assigned to each term in the query is one.

6. The computer-implemented method of claim 5, wherein the value of “k” is set to two.

7. The computer-implemented method of claim 1, wherein obtaining the plurality of attributes associated with the first end-user comprises obtaining at least one attribute from an end-user profile of the first end-user, and obtaining at least one attribute from logged data relating to an interaction the first end-user has had with content via the online service.

8. A system comprising:
a processor configured to execute computer-readable instructions; and
a memory storage device storing computer-readable instructions, which, when executed by the processor, cause the system to:
with training data, train a machine learning model to receive as input a plurality of attributes associated with an end-user of an online service and to generate as output a score for each attribute, the score for an attribute indicating the predictive power of the attribute when used as a term of a query for use in selecting candidate job postings to recommend to the end-user, the training data comprising a plurality of attributes i) obtained for an end-user and job posting pair for which the end-user has previously applied for a job, associated with the job posting, and ii) having at least “k” attributes for the end-user matching corresponding attributes of the job posting;
subsequent to training the machine learning model:
receive a request to generate a plurality of job posting recommendations for a first end-user of the online service;
responsive to receiving the request, obtain a plurality of attributes associated with the first end-user;
provide the plurality of attributes associated with the first end-user as input to the machine learning model to generate for each attribute a score indicating the predictive power of the attribute when used as a term of a query for use in selecting candidate job postings to recommend to the end-user;
derive a query for fetching candidate job postings, the query i) including a term for each attribute in the plurality of attributes for which the machine learning model generated a score that exceeds a predetermined threshold, and ii) when executed against a plurality of job postings, fetches as candidate job postings those job postings in the plurality of job postings that have at least “k” attributes matching attributes expressed in the terms of the query;
execute the query to fetch a plurality of candidate job postings;
process the plurality of candidate job postings to derive a ranking score for each job posting; and
based at least in part on the ranking scores of the plurality of candidate job postings, select a subset of the plurality of job postings for presentation as recommendations to the first end-user.

9. The system of claim 8, wherein the memory storage device is storing additional computer-readable instructions, which, when executed by the processor, cause the system to:
train the machine learning model using as a loss function an approximation of a modified Heaviside Step function, wherein the modified Heaviside Step function evaluates to one, when a job posting has “k” attributes matching attributes of the end-user, and the modified Heaviside Step function evaluates to zero, when a job posting has less than “k” attributes matching attributes of the end-user.

10. The system of claim 8, wherein the memory storage device is storing additional computer-readable instructions, which, when executed by the processor, cause the system to:
derive the query as a weighted OR query.

11. The system of claim 8, wherein the memory storage device is storing additional computer-readable instructions, which, when executed by the processor, cause the system to:
assign to the query a query threshold score; and
assign to each term in the query a weighting factor;
wherein, upon evaluating the query against a particular job posting, a score is derived for the particular job posting by adding the weighting factors of each term of the query associated with an attribute that is present in the job posting; and
fetch the particular job posting as a candidate job posting when the score for the particular job posting exceeds the query threshold score.

12. The system of claim 11, wherein the threshold score is set to the value of “k” and the weighting factor assigned to each term in the query is one.

13. The system of claim 12, wherein the value of “k” is set to two.

14. The system of claim 8, wherein the memory storage device is storing additional computer-readable instructions, which, when executed by the processor, cause the system to:
obtain at least one attribute from an end-user profile of the first end-user, and obtain at least one attribute from logged data relating to an interaction the first end-user has had with content via the online service.

15. A system comprising:
means for training a machine learning model, with training data, to receive as input a plurality of attributes associated with an end-user of an online service and to generate as output a score for each attribute, the score for an attribute indicating the predictive power of the attribute when used as a term of a query for use in selecting candidate job postings to recommend to the end-user, the training data comprising a plurality of attributes i) obtained for an end-user and job posting pair for which the end-user has previously applied for a job, associated with the job posting, and ii) having at least “k” attributes for the end-user matching corresponding attributes of the job posting;
subsequent to training the machine learning model:
means for receiving a request to generate a plurality of job posting recommendations for a first end-user of the online service;
means for obtaining a plurality of attributes associated with the first end-user, responsive to receiving the request;
means for providing the plurality of attributes associated with the first end-user as input to the machine learning model to generate for each attribute a score indicating the predictive power of the attribute when used as a term of a query for use in selecting candidate job postings to recommend to the end-user;
means for deriving a query for fetching candidate job postings, the query i) including a term for each attribute in the plurality of attributes for which the machine learning model generated a score that exceeds a predetermined threshold, and ii) when executed against a plurality of job postings, fetches as candidate job postings those job postings in the plurality of job postings that have at least “k” attributes matching attributes expressed in the terms of the query;
means for executing the query to fetch a plurality of candidate job postings;
means for processing the plurality of candidate job postings to derive a ranking score for each job posting; and
means for selecting a subset of the plurality of job postings for presentation as recommendations to the first end-user, based at least in part on the ranking scores of the plurality of candidate job postings.

16. The system of claim 15, wherein said means for training the machine learning model comprises:
means for using as a loss function an approximation of a modified Heaviside Step function, wherein the modified Heaviside Step function evaluates to one, when a job posting has “k” attributes matching attributes of the end-user, and the modified Heaviside Step function evaluates to zero, when a job posting has less than “k” attributes matching attributes of the end-user.

17. The system of claim 15, wherein said means for deriving a query for fetching candidate job postings comprises:
means for deriving the query as a weighted OR query.

18. The system of claim 15, wherein said means for deriving the query as a weighted OR query comprises:
means for assigning to the query a query threshold score; and
means for assigning to each term in the query a weighting factor;
wherein, upon evaluating the query against a particular job posting, a score is derived for the particular job posting by adding the weighting factors of each term of the query associated with an attribute that is present in the job posting; and
means for fetching the particular job posting as a candidate job posting when the score for the particular job posting exceeds the query threshold score.

19. The system of claim 18, wherein the threshold score is set to the value of “k” and the weighting factor assigned to each term in the query is one.

20. The system of claim 19, wherein the value of “k” is set to two.
